(19) United States
(12) Patent Application Publication
(10) Pub. No.: US 2025/0315748 A1
(43) Pub. Date: Oct. 9, 2025

(54) MULTI-MISSION DISTRIBUTED SPACE VEHICLE MISSION MANAGEMENT ARCHITECTURE

(71) Applicant: Raytheon Company, Tewksbury, MA (US)

(72) Inventors: Thomas W. Thorpe, Parker, CO (US); Jared D. Stallings, Aurora, CO (US); Jason D. Yingst, Castle Rock, CO (US)

(21) Appl. No.: 18/629,625

(22) Filed: Apr. 8, 2024

(51) Int. Cl. G06Q 10/0631

(52) U.S. Cl. CPC G06Q 10/06311

(57) ABSTRACT

Systems, devices, methods, and computer-readable media for space vehicle sensor management. A method includes receiving, at a mission operations center (MOC), respective regional requests from respective regional schedulers, the respective regional requests indicating mission windows (MWs) and corresponding sensors to be operated in associated MWs, receiving, at the MOC, respective sensor plans from corresponding space vehicle operation centers (SVOCs), each sensor plan indicating MWs for which a given sensor is unavailable, generating, based on the regional requests and the sensor plans, a MW apportionment for each regional scheduler, the MW apportionment indicating MWs and corresponding sensors that a user associated with the regional scheduler has authorization to command the sensor, and providing the MW apportionment for the regional scheduler to the regional scheduler.

### TECHNICAL FIELD

Embodiments regard decentralized mission management for space vehicles. Embodiments provide direct control of multiple resources (space and other) to various user organizations so that the user organizations can act independently from one another akin to how they would execute their missions using dedicated resources.

### BACKGROUND

Space systems are built to provide products and services to communities of users. These space systems historically are comprised of a single or small number of space vehicles, with centralized command and control (C&C) capabilities. The C&C capabilities are designed to optimize the use of shared and constrained resources of the space vehicles across the user base. In these centralized C&C systems, user requests are submitted in the form of tasks. The centralized C&C systems generate plans to satisfy the needs. The plans are then sent to the space vehicle for execution. When there are conflicts between tasks from various users, planning services deconflict using optimization schemes which maximize use of resources. The system owner defines the optimization parameters. For example, a commercial space vehicle that performs intelligence, surveillance, and reconnaissance (ISR) collections, such as electro-optical (EO) imagery, may want to optimize planning to maximize profit. Because space resources are shared and constrained, users may only satisfy some of the tasks they request. Similarly, there may be volatility in the schedule as ad hoc requests are received that out-prioritize previously planned activities according to the planning and optimization approach. The result can include frustrated users who cannot rely on the space system to provide the capabilities they need. For example, a user of an ISR resource may want to plan an activity that requires a series of ISR collections over a specific time period. Other elements of the activity depend upon those collections to be completed according to a strict schedule. The organization submits task request but may only receive partial coverage of the overall need. Likewise at any time before the mission activities are executed, those tasks that were planned may be cancelled as other users submit higher priority tasks. The lack of a dedicated resource means that the mission planners cannot formulate a plan to complete the overall mission objectives due to the lack of certainty of the space resource.

In the past decade, the space domain has evolved with lower cost satellites and decreasing launch costs enabling proliferated Low Earth Orbit (pLEO) constellations that offer increased coverage and persistence capabilities to user communities. New pLEO constellations are being devised, developed and delivered to provide services and products to broader sets of users. Some of these users include tactical users who plan and execute complex missions requiring pre-planned and synchronized activities of resources. These users customarily worked with dedicated resources in other domains, such as ground or air, to provide the relevant tactical capabilities. The traditional centralized planning approaches that offer services to global users and use planning and optimization approaches result in unreliable support constellation effectivity.

### BRIEF DESCRIPTION OF DRAWINGS

FIG. 1 illustrates, by way of example, a diagram of an embodiment of a system for satellite operation request receipt and corresponding MAP generation.

FIG. 2 illustrates, by way of example, a diagram of an embodiment of the EMOC.

FIG. 3 illustrates, by way of example, a diagram of an embodiment of a method for space vehicle sensor allocation and management.

FIG. 4 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

Embodiments improve space vehicle system effectivity. Embodiments provide direct control of multiple resources (space and other) to various user organizations so that the user organizations can act independently from one another akin to how they would execute their missions using dedicated resources. Embodiments include an architecture that supports multiple sensors and platforms co-operated at a single regional node.

To overcome these challenges and allow organizations to efficiently and effectively use shared and constrained space resources in support of tactical missions, embodiments include a new decentralized mission management concept has been developed that provides a multi-mission decentralized architecture for users. Embodiments provide direct control of multiple resources (space and other) to various user organizations in such a way as they can act independently from one another akin to how they would execute their missions using dedicated resources. The architecture allows each user organization, within the community of users, to have their own suite of independent mission management capabilities. These capabilities allow direct management of task requests to be performed by one or more space systems, planning of associated activities to satisfy the task requests, execution of planned mission activities (e.g., with direct command of the space vehicles in allocated time windows), and receipt, processing, and dissemination of any data products including any internal exploitation of data to support real-time tasking feedback loops.

The same C&C components that provide the mission management capabilities are available for each user organization. The C&C products can be configured and customized to meet the needs of the user organization. For example, each organization can define their own task prioritization and deconfliction criteria, without affecting any other organization's criteria. A given user organization may also supplement the basic C&C components with any organization specific components.

These C&C components are deployed in support of each organization. In a virtual, cloud-based architecture, a separate stack or instance of these capabilities is instantiated for dedicated use by the user organization. The C&C components allow the user organization to connect to their individualized services. In an on-premises deployment, the C&C components are deployed to and installed on the infrastructure of the user-organization. These C&C components are specific to execution of the mission and do not contain capabilities needed to manage the state of health of the space vehicle resources.

To allow a user organization to assert direct tactical control of multiple sensor resources, an element of centralized control can help ensure multiple user organizations are not attempting to execute mission activities simultaneously using the same space resource(s), and that the space resource(s) have sufficient internal consumables (e.g., power, thermal capacity, data storage capacity, communications bandwidth, a combination thereof, or the like) available to support each organization's desired activities. An enterprise resource allocation capability allocates space resources to the user organizations across a series of different resources and sensors. To receive a resource allocation, a given user organization will submit a Mission Allocation Plan (MAP) request that represents the series of time windows in which they wish to use space resources. User organizations submit MAP requests in advance of upcoming activities to indicate when they would like to use mission resources. MAPs may contain any data or constraints specific to the type of resource and mission at hand, such as consumable needs, locations of interest, attitude/slew needs, sensor types, a combination thereof, or the like. These MAP requests are sent to an enterprise allocation capability. The MAP requests from different user organizations, such as organizations with no affiliation or in different locations, can be in a common messaging format.

The enterprise allocation capability ingests all user organizations MAP requests, and deconflicts requests if a conflict exists, and generates an overall plan for how to allocate the shared and constrained resources across all user requests. The enterprise has a Capacity Allocation Plan (CAP), or set of criteria used to deconflict between requests from multiple organizations. For example, a CAP may indicate a maximum percentage time or consumables that can be allocated to a given user organization in a given time period. A given user allocation of the overall plan can be provided back to the user organization in the form of a MAP. The MAP can include consists internally of a series of “Mission Windows” (MW). An MW represents a period of time that a region is allocated dedicated use of specific space resource, along with a set of consumable limits that must be respected within that period of time. The MAP containing the series of MWs can also include a common message format.

An MOC ensures that space vehicle (SV) resource constraints are not violated when reserving MWs. The MOC is made aware of the SV constraints by using SOC provided SV plans (which contain previous allocated MWs, calibrations, maintenance schedule, etc).

Individual or co-located Satellite Operation Centers (SOCs) will plan each missions maintenance and calibration activities, manage any communications activities such as managing any space vehicle communications contacts with internal or external communications resources, resolution of space vehicle anomalies, trending, analysis and management of space vehicle telemetry and so forth. The SOCs deconflicts any of these maintenance and housekeeping tasks with any mission tasks to ensure the vehicles are available and ready to support a user organization within their allocated MWs.

With the MAPs and vehicle plans, the enterprise SOCs will send commands to the space vehicles to perform any planning maintenance and calibration activities, any communications activities, and commands that prepare them for each planned MW. Then, within a given MW, each user organization will directly command a space vehicle with mission specific commands.

The MAP request and MAP response process can occur at a cadence. The MAP response can represent time windows depending on the mission type. For example, the user organizations may submit MAP requests on a daily basis, and contain 7 days of needs. The resulting daily MAP response can contain new MW allocations for the 7th day, as well as updates to the MWs on the preceding days across multiple SV assets and mission types.

With a given MAP response, the user organization can use their internal and independent mission management capabilities to plan their own mission activities, knowing they have dedicated use of space vehicles outlined in the MWs contained in the MAP. The approach allows the user organization stability in the plan, knowing they have dedicated use of resources over specific time periods, allowing them to generate mission plans that optimize their allocated time on space vehicles in the way that optimizes their missions. It also frees the user organization from worrying about space vehicle platform state of health, and focus solely on the mission.

Embodiments can provide allocation of time and consumables on resources to user organizations across multiple missions. Embodiments provide independent mission management capabilities for each user organization. Embodiments allow a user organization to request for allocation by time and consumable needs and sensor type. Allocation plans of embodiments can be provided in the form of a series of MWs that indicates time and consumables on a specific resource spanning multiple resources. Embodiments provide decentralized mission management across 1-n locations for 1-m sensor/platforms.

Current space systems use centralized mission management solutions with a single instance of mission management capabilities. In prior space systems, a user submits specific task requests focused on a single mission. Embodiments provide centralized control of multiple assets across multiple distributed unconnected users.

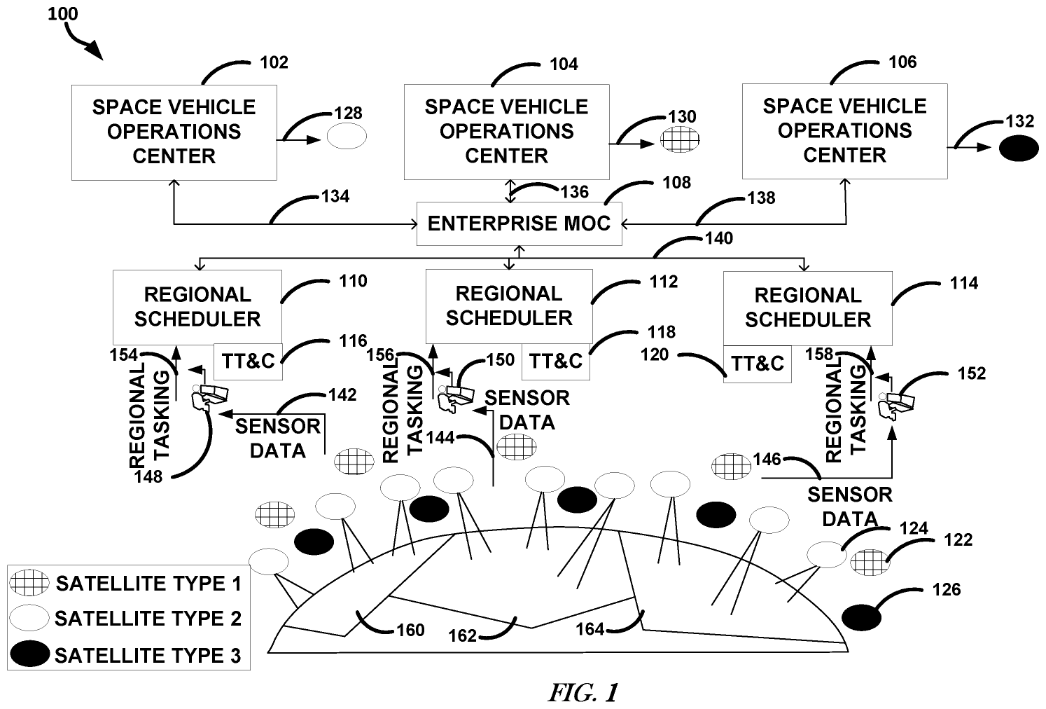

FIG. 1 illustrates, by way of example, a diagram of an embodiment of a system 100 for satellite operation request receipt and corresponding MAP generation. The system 100 as illustrated includes space vehicle operations centers (SVOCs) 102, 104, 106, an enterprise mission operations center (EMOC) 108, regional schedulers 110, 112, 114, and satellites 122, 124, 126. The EMOC 108 is communicatively coupled between the regional schedulers 110, 112, 114 and the SVOCs 102, 104, 106. The MAP is a collection of MW apportionments. That is, a partition of MW apportionments by region, when combined, forms a MAP.

The SVOCs 102, 104, 106 are operated by satellite technology experts. The SVOCs 102, 104, 106 include communications and computer network equipment capable of communicating with the satellites 122, 124, 126. Such equipment includes a radio that transmits and receives communications from the satellites, computer network connections to the EMOC 108, user interfaces, among others.

The SVOCs 102, 104, 106 are responsible for scheduling and maintenance of the satellites 122, 124, 126. The SVOCs 102, 104, 106 send commands to the satellites 122, 124, 126 to perform maintenance and calibration activities, communications, and commands that prepare them for each planned MW. Then, within a given MW, each user organization commands a space vehicle with commands, through TT&C 116, 118, 120 specific to accomplishing the user mission. The satellites 122, 124, 126 carry out operations of the commands and provide gathered data 142, 144, 146 to the SVOCs 102, 104, 106. The SVOCs 102, 104, 106 provide the gathered data 142, 144, 146 to the EMOC 108 which then disseminates the gathered data 142, 144, 146 to the user 148, 150, 152.

The users 148, 150, 152 provide requests 154, 156, 158 for satellite operations to regional schedulers 110, 112, 114. Each regional scheduler 110, 112, 114 is responsible for aggregating requests 154, 156, 158 originating from different geographical regions 160, 162, 164. The regional schedulers 110, 112, 114 has knowledge of the location of satellites 122, 124, 126 through telemetry, tracking, and command (TT&C) 116, 118, 120. TT&C 116, 118, 120 is downlinked platform data (sometimes satellites or space vehicles are referred to as platforms) giving details of the satellite's status, determination of its location through tracking ranging signals, and the uplinked commands given to the platform. The regional schedulers 110, 112, 114 issue MW apportionment requests to the EMOC 108 through communications channel 140. The MW apportionment requests indicate respective commands, respective satellites, and respective times that the user 148, 150, 152 wishes to execute.

The users 148, 150, 152 receive the sensor data 142, 144, 146 associated with the commands they issued to the satellites 122, 124, 126. The users 148, 150, 152 apply the sensor data 142, 144, 146 to their mission and update mission requirements and mission progress accordingly. The users 148, 150, 152 then produce another request 154, 156, 158 for satellite operations to the regional schedulers 110, 112, 114 in accord with updated mission requirements.

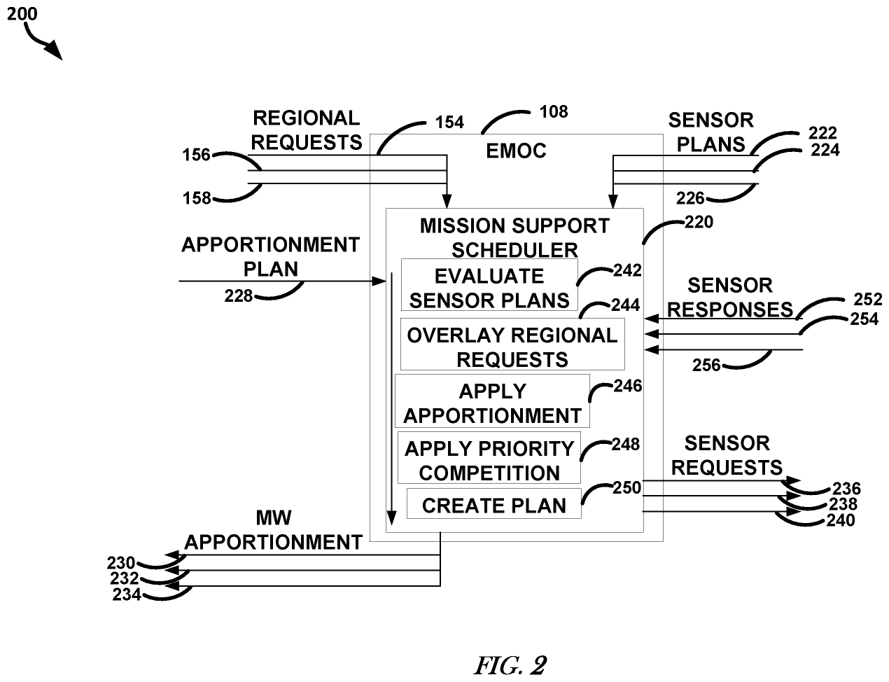

The EMOC 108 is illustrated in more detail in FIG. 2. The EMOC 108 receives the requests 154, 156, 158 from the regional schedulers 110, 112, 114 and issues MW apportionments over the channel 140. The MW apportionments indicate which user has authorization to command which satellite in given MWs. The EMOC issues sensor requests and receives sensor responses 252, 254, 256 (see FIG. 2) over communication channels 134, 136, 138. How the EMOC 108 generates the MW apportionments is discussed in more detail regarding FIG. 2.

The satellite 122, satellite 124, and satellite 126 are different types of satellites. Different types of satellites perform different functions, so they have different sensors onboard. Satellite functions include radar imaging, lidar imaging, infrared imaging, or other imaging. The satellites 122, 124, 126 are merely examples of space vehicles and other space vehicles can be used with, or in place of, the satellites 122, 124, 126. Different types of satellites can be present in a given region at a given time and available for performing operations within the region. At a different time, a same satellite may not be available for performing operations within a region because the satellite orbit has carried it too far away from the region to perform the operation.

FIG. 2 illustrates, by way of example, a diagram of an embodiment of the EMOC 108. The EMOC 108 includes a mission support scheduler 220 that performs operations for MW apportionment 230, 232, 234 generation. The mission support scheduler 220 receives regional requests 154, 156, 158 from respective regional schedulers 110, 112, 114 (see FIG. 1). Respective requests 154, 156, 158 indicate respective sensors, time, and corresponding platform or platforms on which the sensor resides. The requests 154, 156, 158 detail all requests for MWs that span a mission period. The requests 154, 156, 158 can indicate alternative combinations of sensors and MWs that meet mission objectives. The requests 154 are issued from a first geographic region 160, 162, or 164, requests 156 are issued from a second, different geographic region 160, 162, or 164 and requests 158 are issued from a third, different geographic region 160, 162, 164. An example regional request 154, 156, 158 can thus include the following data:

### Region Request

Mission 1 Alternative 1: {Region, User, Sensor, Platform, MW;
   Region, User, Sensor, Platform, MW; . . . }
Mission 1 Alternative 2: {Region, User, Sensor, Platform, MW;
   Region, User, Sensor, Platform, MW; . . . }
. . .
Mission N Alternative M: {Region, User, Sensor, Platform, MW;
   Region, User, Sensor, Platform, MW; . . . }

Where region uniquely indicates one of the regions 160, 162, 164, user uniquely indicates the user associated with the mission, sensor uniquely indicates a type of sensor or an individual sensor, platform uniquely indicates the satellite 122, 124, 126 or type of satellite, and MW indicates a time window in which the sensor is to perform an operation for the user, a priority for the operation, and a configuration that direction to point a sensor, power to use, etc.

The EMOC 108 also receives sensor plans 222, 224, 226 from the SVOC 102. The sensor plans 222, 224, 226 detail bus and sensor plans with prior allocated MWs, outage intervals, communication windows, maintenance, calibration, resource consumption, or other operations that are already scheduled to be performed by the satellites 122, 124, 126. The SV plans include bus and sensors plans with prior allocated MWs, maintenance tasks, outage intervals, comm windows, calibrations with resource consumptions so the mission support scheduler can attempt to schedule the new regional request and still stay within SV/sensor constraints.

### Sensor Plan

Sensor 1: {Platform, Operation, MW;
   Platform, Operation, MW; . . . }
Sensor 2: {Platform, Operation, MW;
   Platform, Operation, MW; . . . }
Sensor O: {Platform, Operation, MW;
   Platform, Operation, MW; . . . }

Where platform uniquely indicates the satellite 122, 124, 126, the operation indicates what is being performed on or by the sensor, and MW indicates a time window in which the operation is being performed, a status (allocated, unallocated, partially allocated, etc.), mission start and end times, a configuration of the sensor before and/or after the operation, etc.

The EMOC 108 also receives an apportionment plan 228. The apportionment plan 228 details high-level constraints on the regional requests 154, 156, 158. The apportionment plan 228 details a maximum amount of sensor resources that can be allocated to a given region. The maximum amount of sensor resources can be defined by numbers of sensors allocated, amount of time allocated on the sensors, a combination thereof, or the like. For example, the apportionment plan 228 can indicate that Region X can only be allocated a maximum of P sensors or a maximum of Q time, whichever is reached first. Where P is an integer and Q is an amount of time. Note that other ways of defining the maximum are possible, such as percentage representations of a total number, for example.

The mission support scheduler 220 receives the regional requests 154, 156, 158 sensor plans 222, 224, 226 and the apportionment plan 228. The mission support scheduler 220 performs operations 242, 244, 246, 248, 250 (e.g., in that order) to generate MW apportionments 230, 232, 234 for each region.

The operation 242 includes identifying pertinent information in the sensor plans 222, 224, 226. The pertinent information can include MWs for which sensors are scheduled for maintenance, calibration, or are otherwise not available. The operation 242 can include inferring MWs for which certain operations may not be performed. For example, if maintenance, calibration, or other operation expends electrical energy and the satellite needs time to gain electrical energy to perform an operation of a request, an MW can be blocked for operations that require more energy than is available at the time associated with the MW.

The operation 244 includes aligning the MWs of the regional requests 154, 156, 158 with the MWs after the sensor plans are evaluated at operation 242. Any regional requests 154, 156, 158 for sensor operations that the sensor is not available are indicated as not possible. Any regional requests 154, 156, 158 for sensor operations that are indicated as not possible due to energy constraints or other constraints of the satellite are also indicated as not possible at operation 244.

At operation 246, the apportionment plan 228 is applied to identify any regional requests 154, 156, 158 that violate apportionment constraints. Any regional requests 154, 156, 158 that might violate apportionment constraints can be flagged as possibly violating constraints.

Based on the indications of not possible, possibly violating constraints, and the remaining regional requests, the mission support scheduler 220 can apply priority to MWs for which there are multiple regional requests 154, 156, 158. The priority can be predefined, definite, and determinative. For any MWs for which there are multiple regional requests 154, 156, 158 and one is flagged as possibly violating constraints, the regional request 154, 156, 158 that is not associated with the flag of possibly violating constraints can be higher priority and selected for inclusion in the plan. For MWs for which there are multiple regional requests 154, 156, 158 and neither is flagged as possibly violating constraints, mission priority can be applied to determine which regional request 154, 156, 158 is allocated the MW. Mission priority can be defined per region and epoch and regions can be prioritized relative to one another in each epoch. The mission priority and the region priority can change each epoch. An epoch is a single round of the mission support scheduler 220 generating sensor requests 236, 238, 240, receiving sensor responses 252, 254, 256, and issuing an MW apportionment 230, 232, 234.

The plan that results from operation 250 is organized per sensor and transmitted as sensor requests 236, 238, 240. The sensor requests 236, 238, 240 are issued to the SVOCs 102, 104, 106. The SVOCs 102, 104, 106 analyze the sensor requests 236, 238, 240 with a more detailed understanding of the capabilities and corresponding energy usage and operation of the satellite 122, 124, 126 than the mission support scheduler 220. The SVOCs 102, 104, 106 can analyze the sensor requests 236, 238, and 240 and determine whether any of the sensor requests 236, 238, 240 are not possible due to operational limitations of the satellite 122, 124, 126 or sensor. The SVOCs 102, 104, 106 in turn will approve (or acknowledge) any of the sensor requests 236, 238, 240 that are possible in a corresponding sensor response 252, 254, 256. The SVOCs 102, 104, 106 will also decline (or negatively acknowledge) any of the sensor requests 236, 238, 240 that are not possible in a correspond sensor response 252, 254, 256.

The mission support scheduler 220 can remove any of the operations of the plan that are declined in a sensor response 252, 254, 256. The result is an MW apportionment 230, 232, 234 for each region. The mission support scheduler 220 issues the MW apportionment 230, 232, 234 to each region. Each region then commands the satellite 122, 124, 126 in their allocated MWs. Each region receives data from the satellite 122, 124, 126 responsive to their commands. Each region updates their mission progress and further regional requests 154, 156, 158 based on the data and the MW apportionment 230, 232, 234. The EMOC 108 receives the next regional requests 154, 156, 158 and performs another epoch of MW apportionment 230, 232, 234 generation.

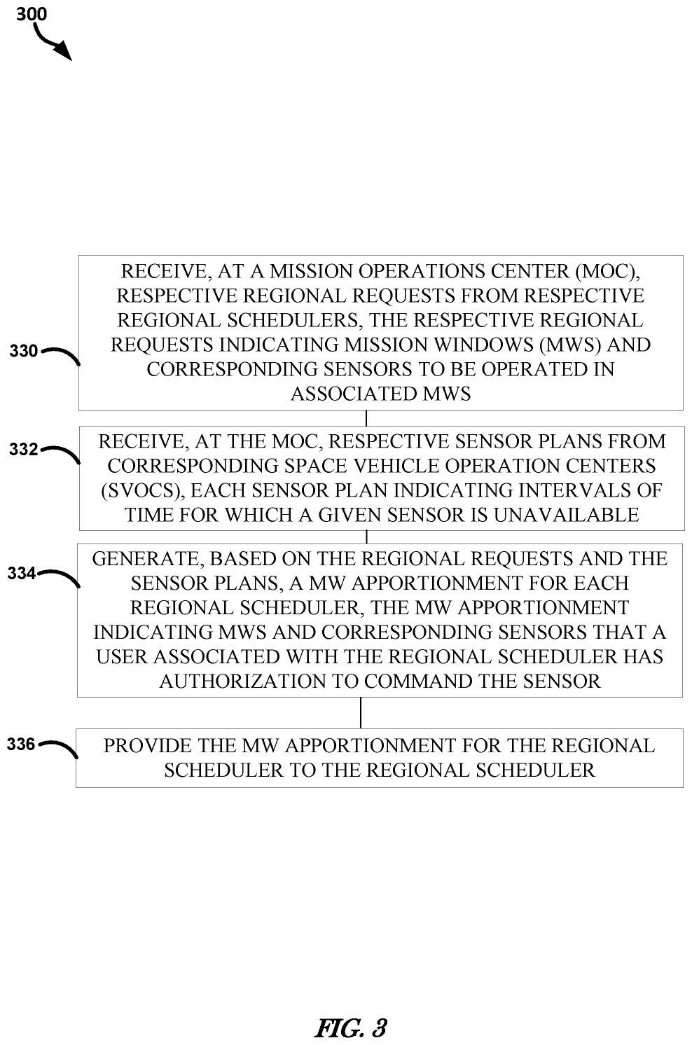

FIG. 3 illustrates, by way of example, a diagram of an embodiment of a method 300 for space vehicle sensor management. The method 300 as illustrated includes receiving, at a mission operations center (MOC), respective regional requests from respective regional schedulers, the respective regional requests indicating mission windows (MWs) and corresponding sensors to be operated in associated MWs, at operation 330; receiving, at the MOC, respective sensor plans from corresponding space vehicle operation centers (SVOCs), each sensor plan indicating MWs for which a given sensor is unavailable (e.g., due to maintenance tasks, outages, calibrations and other mission window blockers), at operation 332; generating, based on the regional requests and the sensor plans, a MW apportionment for each regional scheduler, the MW apportionment indicating MWs and corresponding sensors that a user associated with the regional scheduler has authorization to command the sensor, at operation 334; and providing the MW apportionment for the regional scheduler to the regional scheduler, at operation 336.

The method 300 can further include receiving an apportionment plan that indicates a maximum amount of sensor usage for each region covered by a regional scheduler in a given epoch. The MW apportionment is further generated based on the apportionment plan.

The operation 334 can include evaluating the sensor plans and indicating any MWs requested in the regional requests that conflict with the sensor plans are not possible. The operation 334 can include flagging any MWs requested in the regional requests that are not indicated as not possible and conflict with the apportionment plan as potentially not allowed. The operation 334 can include applying priority to deconflict any MWs for which multiple regional schedulers are requesting access to a same sensor.

Deconflicting the MWs can include allocating the same sensor to a regional scheduler of the regional schedulers that does not have an apportionment plan conflict when another regional scheduler of the regional schedulers has an apportionment plan conflict. Deconflicting the MWs can include allocating the same sensor to a regional scheduler of the regional schedulers that has a higher priority mission.

The operation 334 can include generating sensor requests consistent with a draft MW apportionment. The method 300 can further include providing the sensor requests to the SVOCs. The method 300 can further include receiving sensor responses to the sensor requests, the sensor responses indicating whether a MW request of a sensor request of the sensor requests is approved or denied. The method 300 can further include revising the draft MW apportionment for each of the regional schedulers based on the sensor responses to generate the MW apportionment.

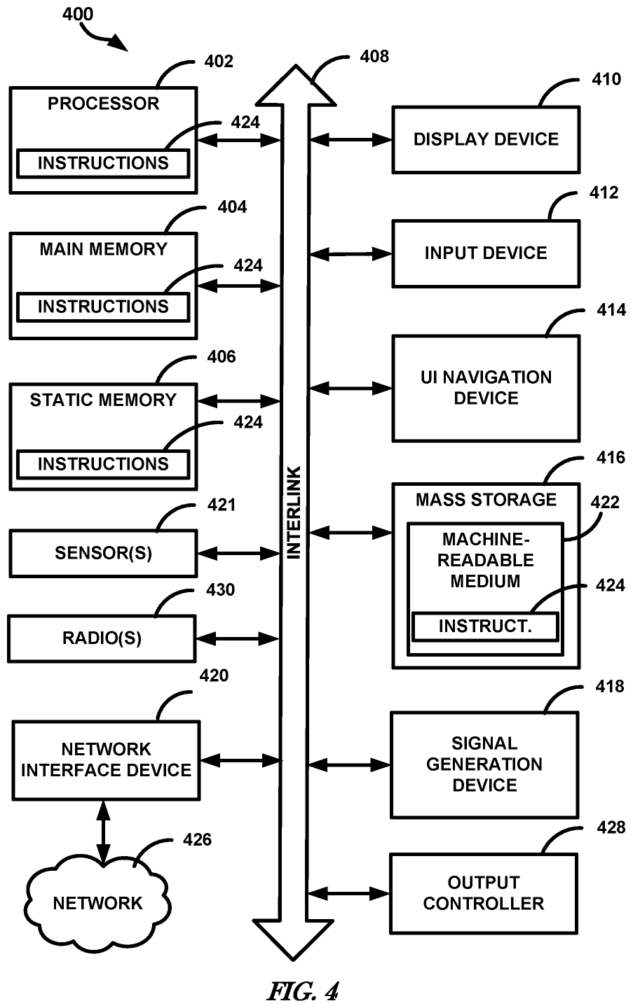

FIG. 4 illustrates, by way of example, a block diagram of an embodiment of a machine in the example form of a computer system 400 within which instructions, for causing the machine to perform any one or more of the methods or techniques discussed herein, may be executed. One or more of the SVOCs 102, 104, 106, MOC 108, regional scheduler 110, 112, 114, satellite 122, 124, 126, mission support scheduler 220, method 300, or other component, operation, or technique, can include, or be implemented or performed by or can include one or more of the components of the computer system 400. In a networked deployment, the machine may operate in the capacity of a server or a client machine in server-client network environment, or as a peer machine in a peer-to-peer (or distributed) network environment. The machine may be a personal computer (PC), server, a tablet PC, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a mass storage unit 416, a signal generation device 418 (e.g., a speaker), a network interface device 420, and a radio 430 such as Bluetooth, WWAN, WLAN, and NFC, permitting the application of security controls on such protocols.

The mass storage unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present teachings, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 424 may further be transmitted or received over a communications network 426 using a transmission medium. The instructions 424 may be transmitted using the network interface device 420 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding, or carrying instructions for execution by the machine, and includes digital or analog communications signals or other intangible media to facilitate communication of such software.

### ADDITIONAL EXAMPLES

Example 1 includes a method for space vehicle sensor management, the method comprising receiving, at a mission operations center (MOC), respective regional requests from respective regional schedulers, the respective regional requests indicating mission windows (MWs) and corresponding sensors to be operated in associated MWs, receiving, at the MOC, respective sensor plans from corresponding space vehicle operation centers (SVOCs), each sensor plan indicating MWs for which a given sensor is unavailable, generating, based on the regional requests and the sensor plans, a MW apportionment for each regional scheduler, the MW apportionment indicating MWs and corresponding sensors that a user associated with the regional scheduler has authorization to command the sensor, and providing the MW apportionment for the regional scheduler to the regional scheduler.

In Example 2, Example 1 further includes receiving an apportionment plan that indicates a maximum amount of sensor usage for each region covered by a regional scheduler in a given epoch, and wherein the MW apportionment is further generated based on the apportionment plan.

In Example 3, Example 2 further includes, wherein generating the MW apportionment for each regional scheduler includes evaluating the sensor plans and indicating any MWs requested in the regional requests that conflict with the sensor plans are not possible.

In Example 4, Example 3 further includes, wherein generating the MW apportionment for each regional scheduler further includes flagging any MWs requested in the regional requests that are not indicated as not possible and conflict with the apportionment plan as potentially not allowed.

In Example 5, Example 4 further includes, wherein generating the MW apportionment for each regional scheduler further includes applying priority to deconflict any MWs for which multiple regional schedulers are requesting access to a same sensor.

In Example 6, Example 5 further includes, wherein deconflicting the MWs includes allocating the same sensor to a regional scheduler of the regional schedulers that does not have an apportionment plan conflict when another regional scheduler of the regional schedulers has an apportionment plan conflict.

In Example 7, Example 6 further includes, wherein deconflicting the MWs includes allocating the same sensor to a regional scheduler of the regional schedulers that has a higher priority mission.

In Example 8, at least one of Examples 1-7 further includes, wherein generating the MW apportionment further includes generating sensor requests consistent with a draft MW apportionment and the method further includes providing the sensor requests to the SVOCs.

In Example 9, at least one of Examples 1-8 further includes receiving sensor responses to the sensor requests, the sensor responses indicating whether a MW request of a sensor request of the sensor requests is approved or denied, and revising the draft MW apportionment for each of the regional schedulers based on the sensor responses to generate the MW apportionment.

Example 10 includes a non-transitory machine-readable medium including instructions that, when executed by a machine, cause the machine to perform operations for space vehicle sensor management by a mission operations center (MOC), the operations comprising operations of one of Examples 1-9.

Example 11 includes a mission operations center (MOC) comprising an input device configured to receive respective regional requests from respective regional schedulers, the respective regional requests indicating mission windows (MWs) and corresponding sensors to be operated in associated MWs, receive respective sensor plans from corresponding space vehicle operation centers (SVOCs), each sensor plan indicating MWs for which a given sensor is unavailable, processing circuitry coupled to the input device, the processing circuitry configured to generate, based on the regional requests and the sensor plans, a MW apportionment for each regional scheduler, the MW apportionment indicating MWs and corresponding sensors that a user associated with the regional scheduler has authorization to command the sensor, and an output device configured to provide the MW apportionment for the regional scheduler to the regional scheduler.

In Example 12, Example 11 further includes, wherein the input device is further configured to receive an apportionment plan that indicates a maximum amount of sensor usage for each region covered by a regional scheduler in a given epoch, and the processing circuitry is configured to generate the MW apportionment is further generated based on the apportionment plan.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for space vehicle sensor management, the method comprising:
receiving, at a mission operations center (MOC), respective regional requests from respective regional schedulers, the respective regional requests indicating mission windows (MWs) and corresponding sensors to be operated in associated MWs;
receiving, at the MOC, respective sensor plans from corresponding space vehicle operation centers (SVOCs), each sensor plan indicating MWs for which a given sensor is unavailable;
generating, based on the regional requests and the sensor plans, a MW apportionment for each regional scheduler, the MW apportionment indicating MWs and corresponding sensors that a user associated with the regional scheduler has authorization to command the sensor; and
providing the MW apportionment for the regional scheduler to the regional scheduler.

2. The method of claim 1, further comprising:
receiving an apportionment plan that indicates a maximum amount of sensor usage for each region covered by a regional scheduler in a given epoch; and
wherein the MW apportionment is further generated based on the apportionment plan.

3. The method of claim 2, wherein generating the MW apportionment for each regional scheduler includes evaluating the sensor plans and indicating any MWs requested in the regional requests that conflict with the sensor plans are not possible.

4. The method of claim 3, wherein generating the MW apportionment for each regional scheduler further includes flagging any MWs requested in the regional requests that are not indicated as not possible and conflict with the apportionment plan as potentially not allowed.

5. The method of claim 4, wherein generating the MW apportionment for each regional scheduler further includes applying priority to deconflict any MWs for which multiple regional schedulers are requesting access to a same sensor.

6. The method of claim 5, wherein deconflicting the MWs includes allocating the same sensor to a regional scheduler of the regional schedulers that does not have an apportionment plan conflict when another regional scheduler of the regional schedulers has an apportionment plan conflict.

7. The method of claim 6, wherein deconflicting the MWs includes allocating the same sensor to a regional scheduler of the regional schedulers that has a higher priority mission.

8. The method of claim 1, wherein generating the MW apportionment further includes generating sensor requests consistent with a draft MW apportionment and the method further includes:
providing the sensor requests to the SVOCs.

9. The method of claim 8, further comprising:
receiving sensor responses to the sensor requests, the sensor responses indicating whether a MW request of a sensor request of the sensor requests is approved or denied; and
revising the draft MW apportionment for each of the regional schedulers based on the sensor responses to generate the MW apportionment.

10. A non-transitory machine-readable medium including instructions that, when executed by a machine, cause the machine to perform operations for space vehicle sensor management by a mission operations center (MOC), the operations comprising:
receiving, at the MOC, respective regional requests from respective regional schedulers, the respective regional requests indicating mission windows (MWs) and corresponding sensors to be operated in associated MWs;
receiving, at the MOC, respective sensor plans from corresponding space vehicle operation centers (SVOCs), each sensor plan indicating MWs for which a given sensor is unavailable;
generating, based on the regional requests and the sensor plans, a MW apportionment for each regional scheduler, the MW apportionment indicating MWs and corresponding sensors that a user associated with the regional scheduler has authorization to command the sensor; and
providing the MW apportionment for the regional scheduler to the regional scheduler.

11. The non-transitory machine-readable medium of claim 10, wherein the operations further comprise:
receiving an apportionment plan that indicates a maximum amount of sensor usage for each region covered by a regional scheduler in a given epoch; and
wherein the MW apportionment is further generated based on the apportionment plan.

12. The non-transitory machine-readable medium of claim 11, wherein generating the MW apportionment for each regional scheduler includes evaluating the sensor plans and indicating any MWs requested in the regional requests that conflict with the sensor plans are not possible.

13. The non-transitory machine-readable medium of claim 12, wherein generating the MW apportionment for each regional scheduler further includes flagging any MWs requested in the regional requests that are not indicated as not possible and conflict with the apportionment plan as potentially not allowed.

14. The non-transitory machine-readable medium of claim 13, wherein generating the MW apportionment for each regional scheduler further includes applying priority to deconflict any MWs for which multiple regional schedulers are requesting access to a same sensor.

15. The non-transitory machine-readable medium of claim 14, wherein deconflicting the MWs includes allocating the same sensor to a regional scheduler of the regional schedulers that does not have an apportionment plan conflict when another regional scheduler of the regional schedulers has an apportionment plan conflict.

16. The non-transitory machine-readable medium of claim 15, wherein deconflicting the MWs includes allocating the same sensor to a regional scheduler of the regional schedulers that has a higher priority mission.

17. The non-transitory machine-readable medium of claim 10, wherein generating the MW apportionment further includes generating sensor requests consistent with a draft MW apportionment and the operations further comprise:
providing the sensor requests to the SVOCs.

18. The non-transitory machine-readable medium of claim 17, wherein the operations further comprise:
receiving sensor responses to the sensor requests, the sensor responses indicating whether a MW request of a sensor request of the sensor requests is approved or denied; and
revising the draft MW apportionment for each of the regional schedulers based on the sensor responses to generate the MW apportionment.

19. A mission operations center (MOC) comprising:
an input device configured to:
receive respective regional requests from respective regional schedulers, the respective regional requests indicating mission windows (MWs) and corresponding sensors to be operated in associated MWs;
receive respective sensor plans from corresponding space vehicle operation centers (SVOCs), each sensor plan indicating MWs for which a given sensor is unavailable;
processing circuitry coupled to the input device, the processing circuitry configured to:
generate, based on the regional requests and the sensor plans, a MW apportionment for each regional scheduler, the MW apportionment indicating MWs and corresponding sensors that a user associated with the regional scheduler has authorization to command the sensor; and
an output device configured to provide the MW apportionment for the regional scheduler to the regional scheduler.

20. The MOC of claim 19, wherein:
the input device is further configured to receive an apportionment plan that indicates a maximum amount of sensor usage for each region covered by a regional scheduler in a given epoch; and
the processing circuitry is configured to generate the MW apportionment is further generated based on the apportionment plan.
